(19) United States
(12) Patent Application Publication
(10) Pub. No.: US 2024/0249374 A1
(43) Pub. Date: Jul. 25, 2024

(54) METHODS AND SYSTEMS FOR MANAGING PERSONNEL SAFETY AT SMART GAS PIPELINE NETWORK STATIONS BASED ON INTERNET OF THINGS

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Bin LIU, Chengdu (CN); Guanghua HUANG, Chengdu (CN)

(73) Assignee: CHENGDU QINCHUAN IOT TECHNOLOGY CO., LTD., Chengdu (CN)

(21) Appl. No.: 18/625,177

(22) Filed: Apr. 2, 2024

(30) Foreign Application Priority Data
Mar. 11, 2024 (CN) 202410268853.7

(51) Int. Cl. G06Q 50/26

(52) U.S. Cl. CPC G06Q 50/265

(57) ABSTRACT

Embodiments of the present disclosure disclose a method for managing personnel safety at a smart gas pipeline network station based on Internet of Things, wherein the method is executed by a smart gas safety management platform of a system for managing personnel safety at a smart gas pipeline network station based on Internet of

Things, comprising: obtaining dispatching data of a gas station; determining a reference personnel frequency of a target region, based on the dispatching data; and in response to a first difference not meeting a first preset condition, giving a first warning, and triggering a risk monitoring; wherein the risk monitoring includes: obtaining monitoring data based on a preset monitoring parameter; determining a risk degree of the target region based on the monitoring data; and in response to the risk degree meeting a second preset condition, giving a second warning.

### CROSS-REFERENCE TO RELATED APPLICATIONS

This application claims priority to Chinese Patent Application No. CN 202410268853.7, filed on Mar. 11, 2024, the entire contents of which are hereby incorporated by reference.

### TECHNICAL FIELD

The present disclosure relates to the field of Internet of Things, and in particular relates to a method and a system for managing personnel safety at a smart gas pipeline network station based on Internet of Things.

### BACKGROUND

At present, gas is widely used in many fields of social life and production, but the technical means of the existing technology for the management of the gas station personnel are often based on the means of monitoring and control, through manual analysis of the monitoring image and video and combined with manual inspection to determine whether there is a risk behavior. However, the management means often consumes a lot of manpower and time costs, and is susceptible to environmental influences and the subjective impact of people, and the monitoring of the efficiency is low.

Therefore, it is desired to provide a method and a system for managing personnel safety at a smart gas pipeline network station based on Internet of Things for a better management of station personnel.

### SUMMARY

One of the embodiments of the present disclosure provides a method for managing personnel safety at a smart gas pipeline network station based on Internet of Things, the method being executed by a smart gas safety management platform of a system for managing personnel safety at a smart gas pipeline network station based on Internet of Things, the method comprising: obtaining dispatching data of a gas station; based on the dispatching data, determining a reference personnel frequency of a target region; in response to a first difference not meeting a first preset condition, giving a first warning, and triggering a risk monitoring, the first difference being a difference between an actual personnel frequency and the reference personnel frequency in the target region; obtaining monitoring data based on a preset monitoring parameter; based on the monitoring data, determining a risk level of the target region; in response to the risk level meeting a second preset condition, giving a second warning.

One of the embodiments of the present disclosure provides a system for managing personnel safety at a smart gas pipeline network station based on Internet of Things, the system comprising: an obtaining module, a determining module and a triggering module; the obtaining module being configured to obtain dispatching data of a gas station; the determining module being configured to determine a reference personnel frequency of a target region based on the dispatching data; the triggering module being configured to give a first warning and trigger a risk monitoring in response to a first difference not meeting a first preset condition, the first difference being a difference between an actual personnel frequency and the reference personnel frequency in the target region; based on a preset monitoring parameter, obtain monitoring data; based on the monitoring data, determine a risk level of the target region; in response to the risk level meeting a second preset condition, give a second warning.

One of the embodiments of the present disclosure provides a non-transitory computer-readable storage medium, comprising a set of instructions, wherein when a computer reads the computer instructions in the storage medium, the method for managing personnel safety at a smart gas pipeline network station based on Internet of Things is implemented

### BRIEF DESCRIPTION OF THE DRAWINGS

This disclosure will be further illustrated by way of exemplary embodiments, which will be described in detail by the accompanying drawings. These embodiments are not limiting, and in these embodiments, the same numbering denotes the same structure, wherein:

FIG. 1 is a schematic diagram illustrating an application scenario of a system for managing personnel safety at a smart gas pipeline network station based on Internet of Things, according to some embodiments of the present disclosure;

FIG. 2 is an exemplary flowchart illustrating a method for managing personnel safety at a smart gas pipeline network station based on Internet of Things, according to some embodiments of the present disclosure;

FIG. 3 is a schematic diagram illustrating a method for determining a reference personnel frequency, according to some embodiments of the present disclosure;

FIG. 4 is a schematic diagram illustrating a method for determining a risk level according to some embodiments of the present disclosure.

### DETAILED DESCRIPTION

The technical schemes of embodiments of the present disclosure will be more clearly described below, and the accompanying drawings need to be configured in the description of the embodiments will be briefly described below. Obviously, the drawings in the following description are merely some examples or embodiments of the present disclosure, and will be applied to other similar scenarios according to these accompanying drawings without paying creative labor. Unless obviously obtained from the context or the context illustrates otherwise, the same numeral in the drawings refers to the same structure or operation.

It should be understood that the “system”, “device”, “unit” and/or “module” used herein is a method for distinguishing different components, elements, parts or assemblies of different levels. However, if other words may achieve the same purpose, the words may be replaced by other expressions.

As shown in the present disclosure and claims, unless the context clearly prompts the exception, “a”, “one”, and/or “the” is not specifically singular, and the plural may be included. It will be further understood that the terms “comprise,” “comprises,” and/or “comprising,” “include,” “includes,” and/or “including,” when used in present disclosure, specify the presence of stated features, integers, steps, operations, elements, and/or components, but do not preclude the presence or addition of one or more other features, integers, steps, operations, elements, components, and/or groups thereof.

The flowcharts are used in present disclosure to illustrate the operations performed by the system according to the embodiment of the present disclosure. It should be understood that the preceding or following operations is not necessarily performed in order to accurately. Instead, the operations may be processed in reverse order or simultaneously. Moreover, one or more other operations may be added to the flowcharts. One or more operations may be removed from the flowcharts.

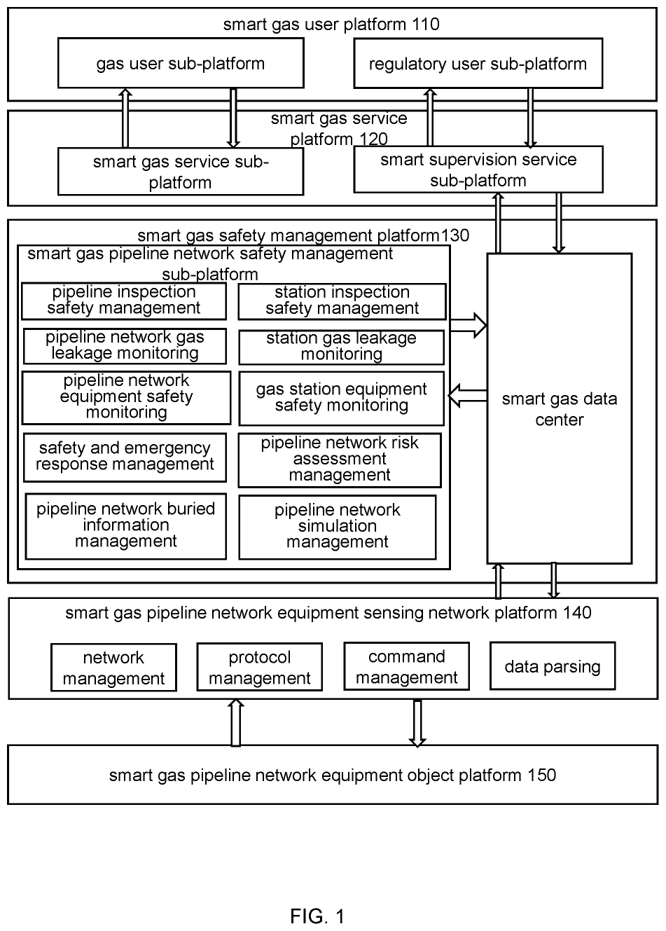

FIG. 1 is a schematic diagram illustrating an application scenario of a system for managing personnel safety at a smart gas pipeline network station based on Internet of Things, according to some embodiments of the present disclosure. As shown in FIG. 1, the system for managing personnel safety at a smart gas pipeline network station based on Internet of Things may include a smart gas user platform 110, a smart gas service platform 120, a smart gas safety management platform 130, a smart gas pipeline network equipment sensor network platform 140, and a smart gas pipeline network equipment object platform 150.

The smart gas user platform 110 refers to a platform for interacting with a user. The user may be a gas user, a regulatory user, etc. In some embodiments, the smart gas user platform 110 may be configured as a terminal device.

In some embodiments, the smart gas user platform 110 may include a gas user sub-platform and a regulatory user sub-platform. The gas user sub-platform may be a platform that provides the gas user with data related to gas usage and solutions to gas problems. The gas user may be an industrial gas user, a commercial gas user, an ordinary gas user, and so on. The regulatory user sub-platform may be a platform that realizes the regulation of the operation of the entire Internet of Things system by the regulatory user. The regulatory user may be a person of a gas safety regulatory department.

In some embodiments, the smart gas user platform 110 may feed information to the user via a terminal device. For example, the smart gas user platform may feed call data to the regulatory user based on the regulatory user sub-platform.

In some embodiments, the gas user sub-platform and the regulatory user sub-platform may interact with the smart gas service sub-platform and the smart regulatory service sub-platform, respectively, of the smart gas service platform 120.

The smart gas service platform 120 may be a platform for communicating a demand and control information from the user. The smart gas service platform 120 may obtain dispatching data etc. from the smart gas pipeline network safety management platform 130 (e.g., the smart gas data center) and send the dispatching data to the smart gas user platform 110.

In some embodiments, the smart gas service platform 120 may include a smart gas consumption service sub-platform and a smart supervision service sub-platform. The smart gas use service sub-platform may be a platform for providing a gas use service for the gas user. The smart supervision service sub-platform may be a platform for providing a supervision need and a supervision program, etc., for the supervision user.

In some embodiments, the smart gas service platform may upload updated at least one gas inspection district to the regulatory user sub-platform of the smart gas user platform 110 based on the regulatory service sub-platform.

The smart gas safety management platform 130 may refer to a platform that provides sensing management and control management functions for the Internet of Things operating system. In some embodiments, the smart gas safety management platform 130 may include a smart gas pipeline network safety management sub-platform and a smart gas data center. The smart gas pipeline network safety management sub-platform interacts with the smart gas data center in both directions.

The smart gas data center may aggregate and store the dispatching data and operational data of the Internet of Things system 100. In some embodiments, the smart gas safety management platform 130 may interact with the smart gas pipeline network equipment sensing network platform 140 and the smart gas service platform 120 (e.g., the smart supervision service sub-platform) via the smart gas data center.

The smart gas pipeline network safety management sub-platform may obtain, through the smart gas data center, the dispatching data and all operational data of the system 100 for managing personnel safety at a smart gas pipeline network station based on Internet of Things, and analyze and process the data.

In some embodiments, the smart gas pipeline network safety management sub-platform may include modules for realizing different management functions, such as a pipeline network inspection safety management, a gas station inspection safety management, a pipeline network gas leakage monitoring, a station gas leakage monitoring, a pipeline network equipment safety monitoring, a gas station equipment safety monitoring, a safety and emergency response management, a pipeline network risk assessment management, a pipeline network buried information management, a pipeline network simulation management, etc. Each management module extracts and sends management data from the data center according to different business data types. When relevant monitoring data exceeds a preset threshold, the system provides an alarm prompt.

The smart gas pipeline network equipment sensing network platform 140 may be a functional platform for managing sensing communications. In some embodiments, the smart gas pipeline network equipment sensing network platform 140 may be configured as a communication network and gateway for performing one or more of network management, protocol management, command management, and data parsing.

In some embodiments, the smart gas pipeline network equipment sensing network platform 140 may interact with the smart gas safety management platform 130 and the smart gas pipeline network equipment object platform 150 to realize the functions of perception information sensing communication and control information sensing communication. For example, the smart gas pipeline network equipment sensing network platform 140 may receive gas station dispatching data uploaded by the smart gas pipeline network equipment object platform 150, or issue an instruction on obtaining the gas station dispatching data to the smart gas pipeline network equipment object platform 150. As another example, the smart gas pipeline network equipment sensing network platform 140 may receive an instruction on obtaining the dispatching data from the smart gas data center, and upload the gas station dispatching data to the smart gas pipeline network equipment object platform 150.

The smart gas pipeline network equipment object platform 150 may refer to a functional platform for obtaining sensing information. In some embodiments, the smart gas pipeline network equipment object platform 150 may be configured as various types of equipment, the various types of equipment including gas pipeline network equipment and other equipment. In some embodiments, the smart gas pipeline network equipment object platform 150 may also be configured as a monitoring device for obtaining data related to a gas pipeline network inspection. For example, the monitoring device may include a gas metering device, an image acquisition device, a temperature and humidity sensor, etc.

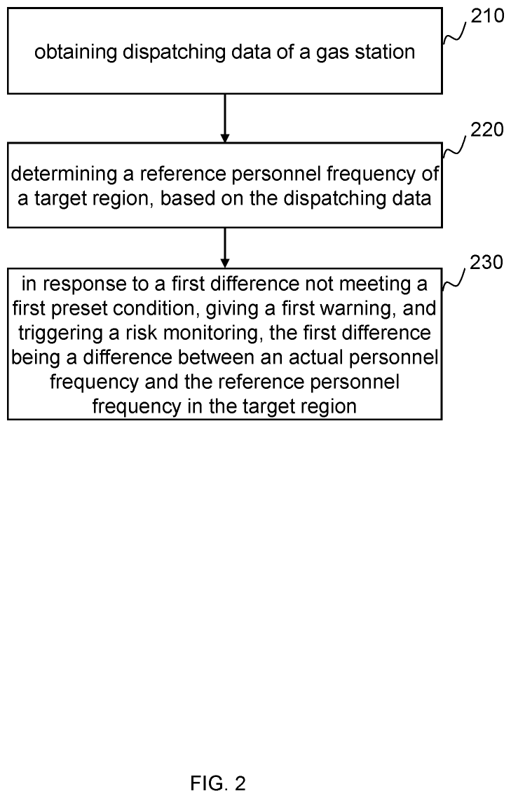

FIG. 2 is an exemplary flowchart illustrating a method for managing personnel safety at a smart gas pipeline network gas station based on Internet of Things, according to some embodiments of the present disclosure.

As shown in FIG. 2, process 200 includes the steps described below. In some embodiments, process 200 may be performed by the smart gas safety management platform 130.

Step 210, obtaining dispatching data of a gas station.

The gas station is a facility for storing, transmitting, and distributing gas, such as natural gas or liquefied petroleum gas (LPG). For example, the gas station typically includes a gas storage tank, a gas transmission pipeline, pressure regulating equipment, metering equipment, safety equipment, etc.

The dispatching data refers to data generated during the operation and dispatching of the gas station. In some embodiments, the dispatching data may be obtained by the smart gas pipeline network equipment object platform and sent to the smart gas data center for storage via the smart gas pipeline network equipment sensing network platform.

In some embodiments, the dispatching data includes gas period data, fault data, personnel data, and inspection data for a plurality of station regions in the gas station.

The station regions refer to regions within the gas station, for example, a gas storage tank region, a gasification region, a pressure regulation region, a metering region, a pipeline region, a control room, etc. The station regions may be provided with various equipment and pipelines, such as a storage tank, a gasifier, a regulator, a metering instrument, a valve, a pipeline, etc., and the aforementioned equipment and pipelines are used to control and manage the flow and use of gas.

The gas period data refers to demand data characterizing the demand for gas at different time periods, e.g., gas demand data during a peak gas consumption period and/or a low gas consumption period.

In some embodiments, the smart gas safety management platform 130 may obtain the gas period data based on an analysis of historical gas data. For example, based on daily, weekly, monthly, and yearly changes in gas usage, daily, weekly, monthly, and yearly gas peaks and/or gas valleys, and their respective corresponding gas usage, are determined.

In some embodiments, the smart gas safety management platform 130 may also determine common patterns and regularities of peak gas usage periods based on staging of historical gas data.

In some embodiments, the gas period data is also influenced by user-specific needs. For example, the gas demand may increase for short periods of time when there is an important event in an area.

In some embodiments, the gas period data is also related to weather conditions. For example, excessive high and low temperatures on a given day may cause an increase in the gas demand.

The fault problem data is data that can react to a gas supply anomaly, and may include a position where the anomaly occurred, a time, a type of anomaly, etc. The type of anomaly may include problems such as a gas supply anomaly, a gas leak, a fire, etc., and the gas supply anomaly may include at least one of a gas supply volume anomaly, a gas supply pressure anomaly, and a gas supply time anomaly.

In some embodiments, the smart gas safety management platform 130 may analyze data from the smart gas object platform and then obtain the fault problem data. For example, a monitoring device and/or a sensor device in the smart gas object platform, e.g., a leak detection device, a fire monitoring device, a pressure detection device, etc., collects data during the operation of the gas pipeline network and uploads the data to the smart gas safety management platform, and the smart gas safety management platform 130 may analyze the data to determine the fault problem data.

The personnel data refers to data reacting to the personnel within the gas station, and may include types of personnel corresponding to different positions, and their corresponding numbers. The personnel types may include managers, technicians, operations personnel, safety managers, maintenance personnel, logistics personnel, etc.

In some embodiments, the smart gas safety management platform 130 may obtain the personnel data through a personnel information maintenance system within the gas station.

The inspection data refers to data that can reflect an inspection situation of the gas station. For example, an inspection time and an inspection position, an inspection item and a result, a rectification situation, etc. The inspection item and the result may include an operation status of the equipment, such as whether the equipment is working normally, whether there is a gas leakage hazard, a fire hazard, and other problems; and the rectification situation includes a rectification measure for an abnormal situation and a completion situation. The specific content of the inspection data may be determined according to actual needs.

In some embodiments, the smart gas safety management platform 130 may obtain the inspection data from the smart gas user platform through the smart gas service platform. For example, the smart gas user platform may obtain the inspection data by collecting user inputs, and upload the inspection data to the smart gas safety management platform 130 via the smart gas service platform.

Step 220, determining a reference personnel frequency of a target region, based on the dispatching data.

The target region refers to a station region that needs to be focused on. For example, regions such as a refueling station, a control room, a gas storage region prone to leaks, a gas purification region prone to fires, a gas intake region, a refueling station, etc., during peak gas times.

In some embodiments, the smart gas safety management platform 130 may determine the target region based on historical data. For example, the smart gas safety management platform 130 may determine a leak-prone region, a fire-prone risk region based on the historical data, and use the aforementioned risk regions as the target region.

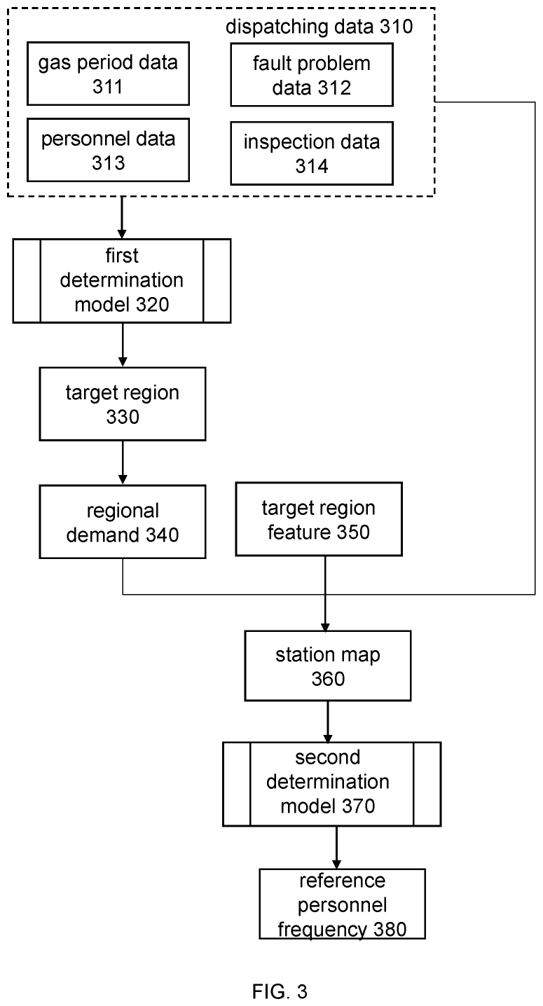

In some embodiments, the smart gas safety management platform 130 may also determine the target region based on the dispatching data. For more information, please refer to FIG. 3 and its related description of the present disclosure.

The reference personnel frequency may refer to a desired personnel frequency of the target region at different times. The personnel frequency refers to a number of occurrences per unit of time in the target region.

In some embodiments, the reference personnel frequency of the target region is related to the time of day, the type of target region, and varies from time to time and from target region to target region. For example, maintenance personnel may need to enter and exit the gas refueling station or the control room more frequently during peak gas usage times, and therefore, a preset reference personnel frequency of the gas refueling station or the control room is higher during peak gas usage times. As another example, a gas leak in the gas storage region is recognized as the target region with the highest priority, and the reference personnel frequency may be adjusted higher accordingly.

In some embodiments, the smart gas safety management platform 130 may determine the reference personnel frequency based on a regional demand of the target region. For more information, please refer to FIG. 3 and its related description of the present disclosure.

Step 230, in response to a first difference not meeting a first preset condition, giving a first warning, and triggering a risk monitoring, the first difference being a difference between an actual personnel frequency and the reference personnel frequency in the target region.

The actual personnel frequency may refer to an actual monitored personnel frequency in the target region.

The first difference refers to a difference between the actual personnel frequency and the reference personnel frequency in the target region. The first difference may be obtained by making a difference between the actual personnel frequency and the reference personnel frequency in the target region.

The first preset condition is used to determine whether to issue the first warning. In some embodiments, the first preset condition may include a first threshold. For example, the first preset condition may be that the difference between the actual personnel frequency and the reference personnel frequency is not greater than the first threshold, and if the aforementioned difference is greater than the first threshold, the first preset condition is not satisfied, and the smart gas safety management platform 130 issues an early warning while triggering the risk degree monitoring.

In some embodiments, the first threshold may be determined based on a priori experience or actual needs.

The first warning is used to indicate a situation where a number of personnel in the gas station does not meet the demands. The first warning may at least include a station region where the number of personnel does not meet the demand, and a difference value between the actual personnel frequency and a reference personnel frequency. In some embodiments, when the actual personnel frequency does not meet the first preset condition, the smart gas safety management sub-platform may send the first warning to the smart gas user platform based on the smart gas service platform.

In some embodiments, the risk degree monitoring is triggered when the actual personnel frequency does not meet the first preset condition.

The risk degree monitoring refers to a process of monitoring a risk degree of unregulated behavior in the target region.

In some embodiments, the smart gas safety management platform 130 may obtain monitoring data based on a preset monitoring parameter; based on the monitoring data, determine a risk degree of the target region; and in response to the risk degree satisfying a second preset condition, issue a second warning.

The preset monitoring parameter may refer to a preset monitoring parameter of a monitoring device in the smart gas pipeline network equipment object platform. For example, a data acquisition frequency, a data acquisition range, etc. The data acquisition frequency refers to a number of times the monitoring device obtains the monitoring data per unit of time, for example, 10 times/minute. The monitoring range refers to a range in which the monitoring device is turned on, such as all turned on, partially turned on, and so on.

The monitoring data refers to data obtained by monitoring the gas station and may include image data, sound data, smoke concentration data, etc. The monitoring data may reflect an irregular behavior in the gas station. For example, smoking, playing with a cell phone, sprinting, shouting, entering and exiting the gas station in an unreasonable manner, etc.

In some embodiments, the monitoring data may be obtained by the smart gas network equipment sensing network platform from the smart gas network equipment object platform.

The risk degree is data reflecting the likelihood of an adverse event occurring in the gas station. The higher the risk degree is, the higher the likelihood of an adverse event occurring in the gas station is. The adverse event includes, but is not limited to, a gas leak, a fire, a gas supply anomaly, etc.

In some embodiments, the smart gas safety management platform 130 may determine the risk degree by querying a risk degree reference table. The risk degree reference table may be determined based on historical data, including a reference risk behavior, and a risk degree corresponding to the reference risk behavior. The smart gas safety management platform 130 may determine a current risk behavior in a current gas station based on the monitoring data, and determine a risk degree for the current risk behavior by querying the risk degree reference table based on the current risk behavior.

In some embodiments, the smart gas safety management platform 130 may also determine the risk degree based on the current risk behavior by means of a preset rule. For more information, please refer to FIG. 3 and its related description of the present disclosure.

The second preset condition is used to determine whether a second alert may be issued. In some embodiments, the second preset condition may include a second threshold. The second threshold is a risk threshold, and the risk threshold may include at least one of a first risk threshold, a second risk threshold.

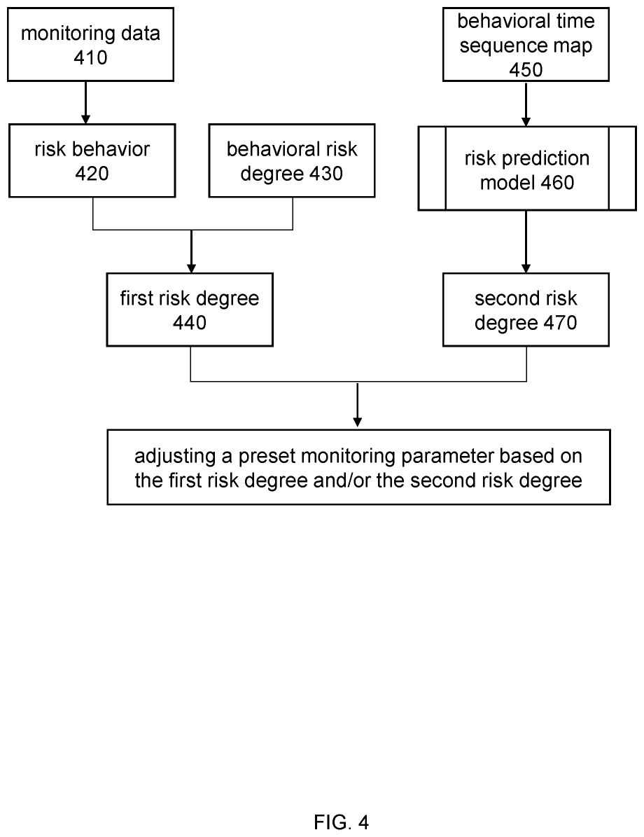

In some embodiments, the second preset condition may include the first risk degree being greater than the first risk threshold, and if the first risk degree is greater than the first risk threshold, the second preset condition is satisfied, and the smart gas safety management platform 130 issues a second warning. For more information about the first risk degree, please refer to FIG. 4 and its related description of the present disclosure.

In some embodiments, the second preset condition may include the first risk degree being greater than the first risk threshold, and/or the second risk degree being greater than the second risk threshold. The first risk threshold and the second risk threshold may be the same value or different values.

In some embodiments, the risk threshold may be determined based on a priori experience or actual needs.

The second warning is used to indicate a situation where the risk degree within the gas station exceeds the risk threshold. The second warning may at least include a risk behavior within the gas station, and a risk value corresponding to the risk behavior. In some embodiments, the smart gas safety management platform may send the second warning to the smart gas user platform based on the smart gas service platform when the risk degree satisfies the second preset condition.

In some embodiments of the present disclosure, by the smart gas safety management platform 130, determining whether or not to perform the risk degree monitoring based on the dispatching data of the gas station and the personnel frequency, and determining whether or not to provide an early warning of the risk based on a result of the risk degree monitoring, the labor cost and time cost of risk management of the gas station may be effectively reduced, and the human error due to the human may be reduced, and the efficiency of the management may be improved.

FIG. 3 is a schematic diagram illustrating a method for determining a reference personnel frequency, according to some embodiments of the present disclosure.

In some embodiments, process 300 may be performed by the smart gas safety management platform 130.

In some embodiments, the smart gas safety management platform 130 may determine a target region 330 based on dispatching data 310, and determine a reference personnel frequency 380 based on a regional demand 340 in the target region.

In some embodiments, the smart gas safety management platform 130 may determine the target region in multiple ways based on the dispatching data.

For example, target regions corresponding to different gas usage periods are different, and the smart gas safety management platform 130 may obtain a peak gas usage period based on gas period data, and determine the refueling station and control room during the peak gas usage period as the target region.

By way of further example, the target region may be determined based on a region affected by a number and severity of faults occurring in the station region, such that the higher the number of faults occurring in the station region and the more severe the faults are, the higher the likelihood that the station region is determined to be the target region.

As another example, the target region may also be determined based on personnel data and inspection data of the station region, such as the less experienced the inspectors of the station region are in their work, the lower the frequency of inspections and the more problems found in the results of the inspections are, the greater the likelihood that the station region is determined to be the target region.

In some embodiments, the smart gas safety management platform 130 may determine a priority order of the station region based on gas period data 311, fault problem data 312, personnel data 313, and inspection data 314, and based on the priority order, determine the target region 330 through a first determination model 320.

In some embodiments, the first determination model may be any one or combination of machine learning models, for example, a deep neural network model (DNN), a convolutional neural network model (CNN), etc., or other customized model structures, etc.

In some embodiments, an input of the first determination model includes gas period data, fault problem data, personnel data, and inspection data for each station region; an output includes a priority order for each station region.

In some embodiments, the gas period data may be represented by a distribution function A(t) of gas usage with respect to time.

In some embodiments, the fault problem data may be represented by a first matrix, where a row of the first matrix represents a situation of a fault problem for a station region, where a number of elements in each row represents a number of fault problems for the station region, and where each element represents a situation of a fault problem. The situation of the fault problem may be represented by a first vector, and a sub-table of elements of the first vector characterizes an overview of the fault problem, an urgency of the fault problem, a severity, etc.

In some embodiments, the personnel data may be represented by a second matrix. One row of the second matrix represents a post situation in a station region, a number of elements in each row represents a number of posts in the station region, and each element represents a post personnel situation. The post personnel situation may be represented by a second vector, wherein the elements of the second vector characterize a number of personnel at the post, and the skills of the personnel, respectively.

In some embodiments, the inspection data may be represented by a third matrix. One row of the third matrix represents an inspection situation for a station region, a number of elements in each row represents a number of inspection devices for the station region, and each element represents an inspection situation associated with an inspection device. The inspection situation may be represented by a third vector, wherein the elements of the third vector characterize whether there is a malfunction of the inspection device, whether there is a hidden danger, the degree of danger of the hidden danger, and the rectification of the malfunction, respectively.

For more information about the gas period data, the fault problem data, the personnel data, and the inspection data, please refer to step 210 and its related descriptions.

The priority order characterizes a priority of the station region to focus on. The priority order may be represented by a numerical value between 0 and 10. A larger value indicates a higher priority order, and a corresponding region is prioritized more to be identified as the target region.

In some embodiments, an output of the model may be a priority sequence that includes a corresponding priority order for each station region.

In some embodiments, the first determination model may be obtained by a plurality of first training samples with first labels, trained by various methods. For example, the training may be based on a gradient descent method. By way of example only, the plurality of first training samples with the first labels may be input into an initial first deterministic model, a loss function may be constructed from the first labels and results of the initial first determination model, and parameters of the initial first determination model may be iteratively updated based on the loss function. When the loss function of the initial first determination model satisfies a preset iteration condition, the model training is completed, and the trained first determination model is obtained. The preset iteration condition may be a loss function convergence, a number of iterations reaching a threshold, etc.

In some embodiments, the first training samples include sample gas period data, sample fault problem data, sample personnel data, and sample inspection data corresponding to a sample station region, and the first training samples may be determined based on preset historical gas data. In some embodiments, the first label is an actual priority order of the sample station region corresponding to the first training sample.

The preset historical gas data is historical data that is preset for training the first determination model and a second determination model. In some embodiments, the smart gas safety management platform 130 may divide a recent period of time (e.g., a year) into a plurality of time intervals (e.g., divide the time intervals into “months”) and determine a task completion degree for each of the time intervals, and in response to a task completion degree of a time interval satisfying a preset task condition, obtain dispatching data during the time interval and determine the preset historical gas data.

The task completion degree is a degree to which personnel have completed a gas task. For example, the gas tasks include repairing a gas valve, replacing a gas meter, etc. The task completion may be expressed in terms of an average time for completion of each gas task, an average degree of stopping of troubleshooting, a number of appliances experiencing a malfunction, etc. For example, the lower the average time for completion of each gas task is, the higher the average degree of stop loss for troubleshooting is, and the lower the number of devices that malfunction is, the higher the task completion degree of the personnel is.

The preset task condition is a condition for determining the preset historical gas data. For example, the preset task condition may include an average time for completion of each gas task being less than a preset time threshold, an average degree of stop loss for troubleshooting being greater than a preset threshold for the degree of stop loss, and a number of devices experiencing a malfunction being less than a preset number threshold. The preset time threshold, the preset threshold for the degree of stop loss, and the preset threshold for the number may be predetermined by the personnel or the processor based on historical experience.

In some embodiments, the task completion degree of the time interval satisfies the preset task condition, indicating that the personnel of each station region within the time interval are accurately and reasonably assigned, thereby maintaining good operation of the station region, and thus the dispatching data corresponding to the time interval is a better choice for use in planning for determining a priority order of each station region.

In some embodiments, the smart gas safety management platform 130 may select a time interval in which the task completion satisfies the preset task condition, and a historical prioritization division corresponding to that time interval is used as a label.

In some embodiments, the smart gas safety management platform 130 identifies a station region with a priority order greater than a preset priority threshold as a target region. The preset priority threshold may be predetermined by personnel or processors based on historical experience.

In some embodiments of the present disclosure, analyzing and processing the gas period data, the fault problem data, the personnel data, and the inspection data by the first determination model can improve the efficiency of processing the data and the accuracy of the priority order of the station region, which can lead to the identification of the target region that needs to be monitored more.

In some embodiments, the smart gas safety management platform 130 may determine a reference personnel frequency 380 based on a regional demand 340 of the target region 320.

The regional demand refers to the personnel needs of the target region. In some embodiments, the regional demand includes a number of personnel in different positions, the distribution of personnel skills, etc. For example, when the target region is a gas storage region where a gas leak occurs, the target region requires a number of personnel in different positions of 1 safety manager, 2 technicians, and 1 maintenance personnel. The distribution of personnel skills for the two technicians, one of whom needs to carry out the overall investigation to locate the problem, one of whom needs to be responsible for troubleshooting.

In some embodiments, the smart gas safety management platform 130 may determine the reference personnel frequency of the target region by means of vector search based on the regional demands. For example, the smart gas safety management platform 130 may construct a vector to be matched based on the regional demands, and elements in the vector to be matched include gas period data, fault problem data, inspection data, personnel data, and personnel needs of the station region; retrieve the vector to be matched based on the vector to be matched in a vector database, obtain a reference vector that has a vector distance from the vector to be matched that is less than a distance threshold, and determine a reference personnel frequency that corresponds to the reference vector as a currently required reference personnel frequency. The vector database stores a number of reference vectors and their corresponding historical reference personnel frequencies. The reference vectors are constructed based on historical regional demands, the historical reference personnel frequencies are actual reference personnel frequencies corresponding to the historical regional demands, and the elements in the reference vectors include reference gas period data, reference fault problem data, reference inspection data, reference personnel data, and reference personnel needs for the reference station regions.

In some embodiments, the smart gas safety management platform 130 may construct a station map 360 based on the dispatching data 310, the regional demand 340, and a target region feature 350; based on the station map 360, determine the reference personnel frequency 380 by a second determination model 370.

The target region feature is data information used to characterize a relationship between two target regions. For example, the target region feature includes an ease of personnel scheduling, a correlation of personnel skill distribution, and a similarity of failure problems between two target regions.

A distance between the target regions is correlated with the ease of personnel scheduling, i.e., the smaller the distance between the two target regions is, the higher the ease of personnel scheduling in the two target regions is; and a position of personnel in the two target regions is correlated with a correlation of the distribution of personnel skills, i.e., the greater the number of personnel with the same position in the two target regions is, the closer the correlation between the distribution of personnel skills in the two target regions is.

The station map is a map that reflects the relationship of individual station regions to each other. The map is a data structure consisting of nodes and edges, with edges connecting nodes, and nodes and edges may have attributes. The nodes of the station map represent target regions. Node features corresponding to the nodes of the station map include the dispatching data and the regional demand of the target region.

The edges of the station map represent correlations between the target regions. The correlations may include an adjacency between two target regions, or, alternatively, a temporal adjacency between the target regions, for example, a temporal adjacency between a station region targeted by a current process and another station region targeted by a next process in a process of station management. The edge features corresponding to the edges of the station map are target region features. The edge features may include, a distance between the target regions, a correlation in the distribution of personnel skills between the two regions, a similarity in failure problems, etc.

In some embodiments, the second determination model may be a machine learning model. For example, a graph neural networks model (GNN). The second determination model may also be another graph model, such as a graph convolutional neural network model (GCNN), or other processing layers may be added to the graph neural network model, modifications made to its processing, etc.

In some embodiments, an input of the second determination model includes the station map, and an output includes the reference personnel frequency of the target region (i.e., a node). For more information about the reference personnel frequency, please refer to FIG. 2 and its related description.

In some embodiments, the second determination model may be obtained by a plurality of second training sample with second labels, trained by various methods. For example, the training may be based on a gradient descent method. The second determination model is trained in a similar manner as the first determination model, as may be described above.

In some embodiments, the second training samples includes a sample station map, which may be constructed based on preset historical gas data.

In some embodiments, the second labels may include historical actual personnel frequencies corresponding to the sample region in the second training samples. The historical actual personnel frequencies may be determined based on the preset historical gas data. For more information about the preset historical gas data, please refer to the previous description thereof.

In some embodiments, the smart gas safety management platform 130 may filter a time interval in which the task completion degree meets a preset condition, and use the historical actual personnel frequencies of the sample region in the time interval as the training label.

In some embodiments of the present disclosure, analyzing and processing the station map by the second determination model may improve the processing efficiency of the data and accurately determine the reference personnel frequency of the target region.

In some embodiments of the present disclosure, the target region is determined through the dispatching data, thereby determining the reference personnel frequency based on the regional demand of the target region, which enables the target region to more rationally assign management personnel based on the reference personnel frequency, effectively reducing the probability and cost of an incident.

FIG. 4 is a schematic diagram illustrating a method for determining a risk degree according to some embodiments of the present disclosure.

As shown in FIG. 4, process 400 includes the following. In some embodiments, process 400 may be performed by the smart gas safety management platform 130.

In some embodiments, the risk degree includes at least a first risk degree.

The first risk degree is for assessing a severity of a risk of an incident that may result from the risk behavior in the target region. The first risk degree may be expressed as a numerical value, with a larger value indicating a greater severity of the risk that the target region may result from the risk behavior.

In some embodiments, the smart gas safety management platform 130 may determine, based on the monitoring data 410, a risk behavior 420, and based on the risk behavior 420 and a behavioral risk degree 430 corresponding to the risk behavior, determine, by a preset rule, the first risk degree 440.

The risk behavior is a behavior performed by personnel that may result in a risk of an accident in the target region. For example, the risk behavior includes smoking, playing with a cell phone, sprinting, shouting, entering and exiting a gas station randomly, and failing to follow the required dress code.

In some embodiments, the smart gas safety management platform 130 may determine the risk behavior 420 in a variety of ways based on the monitoring data 410. e.g., whether the personnel are engaging in the risk behavior is captured via a surveillance camera. As another example, the presence or absence of smoke in the target region is detected via a smoke detector to determine whether the personnel are engaged in smoking behavior.

In some embodiments, the smart gas safety management platform 130 may obtain image data, sound data, and smoke data of the target region based on the monitoring data; and determine the risk behavior based on the image data, the sound data, and the smoke data.

The monitoring data are data obtained by monitoring different areas of the gas station, as more described in the related description in FIG. 2.

In some embodiments, the smart gas safety management platform 130 may extract the image data, the sound data, and the smoke data therefrom by analyzing the monitoring data.

The image data refers to data information associated with an image having personnel behavior.

In some embodiments, the image data includes a motion feature of the personnel. The motion feature is data information used to characterize the personnel's behavior. In some embodiments, the motion feature includes a speed feature, an acceleration feature, etc., of the personnel behavior.

The speed feature is data information used to characterize a movement speed of the personnel. For example, the speed feature includes a speed extreme difference, a number of changes in a speed direction, and a time at which the speed exceeds a threshold. The speed extreme difference is a difference between a maximum value of a movement speed of the personnel minus a minimum value of the speed; the number of changes in the speed direction is a number of times the speed of the movement speed of the personnel changes direction during a first preset time period; and the time at which the speed exceeds the threshold is a total length of time at which the speed of the personnel's movement speed is greater than a preset speed threshold during a second preset time period.

The acceleration feature is data information that characterizes the acceleration of the personnel (meaning body movement or limb movement). For example, the acceleration feature includes an acceleration duration, an acceleration over threshold time of the personnel. The acceleration duration is a total length of time during which the acceleration of the personnel is greater than 0 during a third preset time period, and the acceleration over threshold time is a total length of time during which the acceleration of the personnel is greater than a preset acceleration threshold during a fourth preset time period.

In some embodiments, the presence of a behavior with acceleration by personnel is indicative of the presence of a behavior with force by personnel, and thus the acceleration duration may be used to characterize the likelihood of a fight, the intensity of the fight, etc. The longer the acceleration duration is, the more likely a fight is to occur and the more intense the fight may be. Accordingly, the greater the acceleration of the personnel is, the greater the force of the personnel is, and the more dangerous the corresponding action behavior is.

The preset speed threshold, the first preset time period, the second preset time period, the third preset time, the fourth preset time, and the preset acceleration threshold may be predetermined based on historical experience and/or actual needs.

In some embodiments, the smart gas safety management platform 130 may determine the risk behavior by means of vector retrieval based on the motion feature. For example, the smart gas safety management platform 130 may construct a motion feature vector containing a speed feature and an acceleration feature based on the motion feature at a preset time, and elements in the motion feature vector include at least the speed feature and the acceleration feature; compare the motion feature vector with a reference feature vector in the vector database, compare similarities between the two, and take the reference feature vector with a similarity that meets a condition as a target vector, and determine the risk behavior based on a reference risk behavior corresponding to the target vector.

The vector database includes a reference feature vector and its corresponding reference risk behavior. The reference feature vector is determined based on historical motion features.

The sound data refers to data information related to the personnel's voice. For example, a decibel, a duration, etc., of the personnel's voice. In some embodiments, the smart gas safety management platform 130 may determine, via a sound sensor, a number of points in time when the decibel of the personnel's voice is greater than a preset decibel threshold, and if the number of such points in time is greater than a preset quantity threshold, the personnel is indicated to have a risk behavior of shouting loudly. The preset decibel threshold and the preset quantity threshold may be predetermined based on historical experience and/or actual needs.

The smoke data is data information related to smoke in the target region. For example, the smoke data may include a concentration, a duration, etc. of the smoke.

In some embodiments, the smart gas safety management platform 130 may determine whether the personnel in the target region have a risk behavior of smoking by means of a smoke alarm, i.e., if an alarm occurs in the smoke alarm then the personnel have a risk behavior of smoking.

In some embodiments of the present disclosure, the image data, the sound data, and the smoke data can more accurately determine a specific risk behavior present in the target region, so that an emergency measure may be taken in a timely manner to avoid the risk of an accident.

In some embodiments, the smart gas safety management platform 130 may determine the first risk degree based on the risk behavior, and a behavioral risk degree corresponding to the risk behavior, by means of a preset rule.

The behavioral risk degree is a risk degree of the risk behavior in the target region. The behavioral risk degree may be expressed as a numerical value, with a larger value indicating a greater risk degree of the risk behavior within the target region.

In some embodiments, the smart gas safety management platform 130 may determine the behavioral risk degree by looking up a risk degree reference table. A behavioral risk degree reference table may be set in advance, and different risk behaviors in different target regions correspond to different behavioral risk degrees, for example, “smoking” in the gas storage region has the highest risk degree, but “smoking” in the control room has a slightly lower risk degree, which may be determined based on a priori experience. The smart gas safety management platform 130 may determine the behavioral risk degree based on the risk behavior and its corresponding occurrence region.

In some embodiments, the smart gas safety management platform 130 may analyze the monitoring data of the target time period to identify one or more risk behaviors; based on the behavioral risk degree of the one or more risk behaviors, it determines, by means of a preset rule, the risk degree of the target region. The target time period may be a time period determined based on actual needs.

The preset rules may include performing a weighted sum of the behavioral risk degrees corresponding to the one or more risk behaviors, and determining a value of the weighted sum as the first risk degree.

In some embodiments, weights in the weighted sum are related to a frequency of the risk behavior and a historical mis-judgement rate, with the historical misjudgment rate being a probability of a misjudgment of the risk behavior in a past time. For example, the greater the number of times and the smaller the historical mis-judgement rate that a risk behavior has occurred in a previously preset time is, the greater the weight of the behavioral risk degree of the risk behavior is.

The frequency of the risk behavior refers to a number of times the risk behavior occurred during historical time periods.

The historical misjudgment rate may be determined based on an analysis of historical data, for example, the smart gas safety management platform 130 may determine whether or not a risk behavior is misclassified by analyzing results of each judgment of the risk behavior in a certain historical time period to determine the historical misjudgment rate based on a ratio of a number of misjudgments to a total number of judgments of the risk behavior.

Whether or not the risk behavior is misjudged may be determined based on the results of the risk behavior judgments in the historical data and whether or not the behavior resulted in adverse impacts. A misjudgment of a behavior exists when the behavior is determined to be a risk behavior but does not actually result in any adverse impacts. The adverse impacts can include a variety of situations that have an impact on a normal operation and work of the gas station.

In some embodiments of the present disclosure, the smart gas safety management platform 130 determines the first risk degree based on a plurality of behavioral risk degrees by means of a preset rule, which is able to improve the accuracy of the first risk degree and reduce the probability of misjudgment, so that when the first risk degree exceeds the preset risk degree threshold, a warning is issued to the personnel in a timely manner, which is able to take a measure before the occurrence of a risk accident, thereby reducing a risk accident frequency and a severity of a risk accident.

In some embodiments, the risk degree also includes a second risk degree, and the smart gas safety management platform 130 may construct a behavioral time sequence map 450 based on a risk behavior and an occurrence time of the risk behavior; based on the behavioral time sequence map 450, predict the second risk degree 470 by a risk prediction model 460.

The second risk degree is an assessment of a severity of a risk of an accident occurring in the target region as a result of a possible future risk behavior.

The behavioral time sequence map is a map that captures a spatial and temporal feature of an occurrence of a risk behavior by the personnel in the target region. The map is a data structure comprising nodes and edges, with edges connecting nodes, and nodes and edges may have attributes.

The nodes of the behavioral time sequence map represent risk behaviors occurring by personnel in the target time period, and the nodes of the behavioral time sequence map correspond to node features that are risk behavioral features. The risk behavior feature is data information that reflects a feature of the risk behavior. For example, the risk behavior feature includes a type of the risk behavior (e.g., jostling behavior, running behavior, etc.), an occurrence time, an occurrence position, and a behavior speed.

Edges of the behavioral time sequence map include a first type of edges and a second type of edges.

The first type of edges are edges formed by connecting risk behaviors of the same personnel that occur in time-consecutive succession. For example, two risk behaviors of a personnel occurring sequentially in time are connected to form the first type of edges. Edge features corresponding to the first type of edges of the behavioral time sequence map include a time difference and a change feature between the two risk behaviors occurring sequentially in time. The change feature is data information used to reflect the feature of the change of the two risk behaviors occurring sequentially in time. For example, if the two risk behaviors occurring sequentially in time include a running behavior and a jostling behavior, the change feature may include a running distance, a jostling action feature, and so on.

The second type of edges are edges formed by connecting multiple risk behaviors that are spatially associated. For example, risk behaviors occurring in adjacent spaces at the same time have the second type of edges between them, and the aforementioned spaces may refer to sub-regions in the target region. Edge features corresponding to the second type of edges of the behavioral time sequence map include a spatial distance, a spatial feature, etc., of the space where the node (i.e., the risk behavior) is located.

The spatial feature is used to reflect data information that characterizes the space in which the node (i.e., the risk behavior) is located. For example, whether the space where the node (i.e., the risk behavior) is located has hazardous equipment, whether an operational operation is required, and a type of operation present. The space where the node is located refers to a sub-region of the target region where the risk behavior occurs.

In some embodiments, the smart gas safety management platform 130 may by means of a clustering algorithm, cluster the nodes based on the features of the risk behaviors corresponding to the nodes and determine a clustering center as class nodes of a new behavioral time sequence map. The feature of the risk behavior may include at least a motion feature of the risk behavior, the presence or absence of interaction with other personnel, etc. For more information about the motion feature, please refer to the previous related description.

The class nodes are used to characterize the risk behaviors in which multiple people are involved. For example, the class nodes may characterize a jostling behavior, a chasing behavior, etc. that occurs between multiple people.

In some embodiments, the edges of the behavioral time sequence may also include a third type of edges. The third type of edge is used to connect the nodes, and may represent relationships between risk behaviors having different behavioral features.

In some embodiments, the risk prediction model may be a machine learning model, e.g., a graph neural networks model (GNN). The risk prediction model may also be other graph models, e.g., a graph convolutional neural network model (GCNN), or other processing layers may be added to the graph neural network model, modifications made to the processing thereof, etc.

In some embodiments, an input of the risk prediction model includes a behavioral time sequence map 450, and an output includes a second risk degree 470 of the target region.

In some embodiments, the risk prediction model may be trained by various methods through a plurality of third training sample with third labels. For example, the risk prediction model may be trained based on a gradient descent method. The risk prediction model is trained in a similar manner as the first deterministic model, as may be described above.

In some embodiments, the third training samples include a sample behavioral time sequence map of at least one historical target region, which may be constructed based on the at least one historical target region and its corresponding historical risk behavior data. The historical risk behavior data includes at least a type of historical risk behavior, a historical occurrence time, a historical occurrence position, and a historical behavior rate.

In some embodiments, the third labels are actual second risk degrees of historical target regions, which may be determined based on historical risk rows in the historical target regions, and an assessment of consequences of the aforementioned historical risk behaviors. For example, the losses (e.g., smoking leading to fires and explosions, multiple people fighting leading to injuries and missed work, etc.) and the severity of the losses are assessed, and the second risk degree is scored based on the severity of the losses, with a higher score indicating a higher second risk degree.

In some embodiments of the present disclosure, analyzing and processing the behavioral time sequence map by the risk prediction model may improve a processing efficiency of data and may improve an accuracy of a predicted second risk degree.

In some embodiments, the smart gas safety management platform 130 may adjust the preset monitoring parameter based on the first risk degree and/or the second risk degree. For example, the higher the first risk degree and/or the second risk degree of the target region is, the greater the monitoring frequency and monitoring range is.

In some embodiments, the smart gas safety management platform 130 may determine a preset parameter based on the first risk degree and the second risk degree via a parameter relationship table. The parameter relationship table is a table of correspondences between the first risk degree, the second risk degree both and the preset monitoring parameter, and the parameter relationship table may be constructed based on correspondences between historical first risk degrees, historical second risk degrees both and historical preset parameters.

In some embodiments, the preset parameter is related to a value of a weighted sum of the first risk degree and the second risk degree, and the weights of the first risk degree and the second risk degree are ratios of the first risk degree and the second risk degree, respectively. For example, the greater the value of the weighted sum of the first risk degree and the second risk degree is, the greater the monitoring frequency and the monitoring range is.

For more information about the preset parameter, please refer to FIG. 2 and its related descriptions.

In some embodiments of the present disclosure, the preset parameter is adjusted by the first risk degree and/or the second risk degree to avoid unnecessary energy consumption caused by a capture frequency and a capture range being too large when the likelihood of an accident risk occurring in the target region is small, and at the same time, when the likelihood of an accident risk occurring in the target region is large, the capture frequency and the capture range may be timely adjusted to be larger to timely remind the personnel to avoid an accident.

In some embodiments, a non-transitory computer-readable storage medium is further provided, comprising a set of instructions, wherein when a computer reads the computer instructions in the storage medium, the method for managing personnel safety at a smart gas pipeline network gas station based on Internet of Things is implemented.

The basic concepts have been described above, apparently, in detail, as will be described above, and does not constitute limitations of the disclosure. Although there is no clear explanation here, those skilled in the art may make various modifications, improvements, and modifications of present disclosure. This type of modification, improvement, and corrections are recommended in present disclosure, so the modification, improvement, and the amendment remain in the spirit and scope of the exemplary embodiment of the present disclosure.

At the same time, present disclosure uses specific words to describe the embodiments of the present disclosure. As “one embodiment”, “an embodiment”, and/or “some embodiments” means a certain feature, structure, or characteristic of at least one embodiment of the present disclosure. Therefore, it is emphasized and should be appreciated that two or more references to “an embodiment” or “one embodiment” or “an alternative embodiment” in various parts of present disclosure are not necessarily all referring to the same embodiment. Further, certain features, structures, or features of one or more embodiments of the present disclosure may be combined.

In addition, unless clearly stated in the claims, the order of processing elements and sequences, the use of numbers and letters, or the use of other names in the present disclosure are not used to limit the order of the procedures and methods of the present disclosure. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

At last, it should be understood that the embodiments described in the present disclosure are merely illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for managing personnel safety at a smart gas pipeline network station based on Internet of Things, wherein the method is executed by a smart gas safety management platform of a system for managing personnel safety at a smart gas pipeline network station based on Internet of Things, comprising:
obtaining dispatching data of a gas station;
determining a reference personnel frequency of a target region, based on the dispatching data; and
in response to a first difference not meeting a first preset condition, giving a first warning, and triggering a risk monitoring, the first difference being a difference between an actual personnel frequency and the reference personnel frequency in the target region; wherein
the risk monitoring includes:
obtaining monitoring data based on a preset monitoring parameter;
determining a risk degree of the target region based on the monitoring data; and
in response to the risk degree meeting a second preset condition, giving a second warning.

2. The method of claim 1, wherein the determining a reference personnel frequency of a target region, based on the dispatching data includes:
determining the target region, based on the dispatching data; and
determining the reference personnel frequency, based on a regional demand of the target region.

3. The method of claim 2, wherein the dispatching data includes at least one of gas period data, fault data, personnel data, and inspection data of a plurality of gas station regions in the gas station.

4. The method of claim 3, wherein the determining the target region, based on the dispatching data includes:
determining a priority order of the plurality of gas station regions based on the dispatching data by a first determination model, and the first determination model being a machine learning model; and
determining the target region, based on the priority order.

5. The method of claim 2, wherein the determining the reference personnel frequency, based on a regional demand of the target region includes:
constructing a station map based on the dispatching data, the regional demand, and a target regional feature; and
determining the reference personnel frequency based on the station map by a second determination model, and the second determination model being a machine learning model.

6. The method of claim 1, wherein the risk degree includes at least a first risk degree; and
the based on the monitoring data, determining a risk degree of the target region includes:
determining a risk behavior, based on the monitoring data; and
determining the first risk degree based on the risk behavior and a behavioral risk degree corresponding to the risk behavior, by a preset rule.

7. The method of claim 6, wherein the determining a risk behavior, based on the monitoring data includes:
determining at least one of image data, sound data, and smoke data of the target region, based on the monitoring data; and
determining the risk behavior, based on at least one of the image data, the sound data, and the smoke data.

8. The method of claim 6, wherein the risk degree also includes a second risk degree; and
the based on the monitoring data, determining a risk degree of the target region also includes:
constructing a behavior time sequence map based on the risk behavior and an occurrence time of the risk behavior; and
predicting the second risk degree based on the behavior time sequence map, by a risk prediction model, and the risk prediction model being a machine learning model.

9. The method of claim 8, wherein the preset monitoring parameter is adjusted based on at least one of the first risk degree and the second risk degree.

10. A system for managing personnel safety at a smart gas pipeline network station based on Internet of Things, wherein the system includes a smart gas user platform, a smart gas service platform, a smart gas safety management platform, a smart gas pipeline network equipment sensor network platform and a smart gas pipeline network equipment object platform;
the smart gas safety management platform being configured to:
obtaining a dispatching data of a gas station;
determining a reference personnel frequency of a target region, based on the dispatching data; and
in response to a first difference not meeting a first preset condition, giving a first warning, and triggering a risk monitoring, the first difference being a difference between an actual personnel frequency and the reference personnel frequency in the target region; wherein
the risk monitoring includes:
obtaining monitoring data based on a preset monitoring parameter;
determining a risk degree of the target region based on the monitoring data;
in response to the risk degree meeting a second preset condition, giving a second warning.

11. The Internet of Things system of claim 10, wherein the smart gas safety management platform includes a smart gas pipeline network safety management sub platform and a smart gas data center;
the smart gas safety management platform interacts information with the smart gas service platform and the smart gas pipeline network equipment sensor network platform through the smart gas data center.

12. The Internet of Things system of claim 11, wherein the smart gas safety management platform is further configured to:
determine the target region, based on the dispatching data; and
determine the reference personnel frequency, based on a regional demand of the target region.

13. The Internet of Things system of claim 12, wherein the dispatching data includes at least one of gas period data, fault data, personnel data, and inspection data of a plurality of gas station regions in the gas station.

14. The Internet of Things system of claim 13, wherein the smart gas safety management platform is further configured to:
determine a priority order of the plurality of gas station regions based on the dispatching data by a first determination model, and the first determination model being a machine learning model; and
determine the target region, based on the priority order.

15. The Internet of Things system of claim 12, wherein the smart gas safety management platform is further configured to:
construct a station map based on the dispatching data, the regional demand, and a target regional feature; and
determine the reference personnel frequency based on the station map by a second determination model, and the second determination model being a machine learning model.

16. The Internet of Things system of claim 11, wherein the risk degree at least includes a first risk degree; and
the smart gas safety management platform is further configured to:
determine a risk behavior, based on the monitoring data; and
determine the first risk degree based on the risk behavior and a behavioral risk degree corresponding to the risk behavior, by a preset rule.

17. The Internet of Things system of claim 16, wherein the smart gas safety management platform is further configured to:
determine at least one of image data, sound data, and smoke data of the target region, based on the monitoring data; and
determine the risk behavior, based on at least one of the image data, the sound data, and the smoke data.

18. The Internet of Things system of claim 16, wherein the risk degree also includes a second risk degree; and
the smart gas safety management platform is further configured to:
construct a behavior time sequence map based on the risk behavior and an occurrence time of the risk behavior; and
predict the second risk degree based on the behavior time sequence map, by a risk prediction model, and the risk prediction model being a machine learning model.

19. The Internet of Things system of claim 18, wherein the preset monitoring parameter is adjusted based on at least one of the first risk degree and the second risk degree.

20. A non-transitory computer-readable storage medium, comprising a set of instructions, wherein when a computer reads the computer instructions in the storage medium, the method for managing personnel safety at a smart gas pipeline network station based on Internet of Things of claim 1 is implemented.
